(19) United States
(12) Patent Application Publication
(10) Pub. No.: US 2021/0003121 A1
(43) Pub. Date: Jan. 7, 2021

(54) PROCESS FOR OPERATING A SINGLE-STROKE COMBUSTION ENGINE

(71) Applicant: KISS-Engineering Inc., Northridge, CA (US)

(72) Inventor: Christopher L. Gamble, Canoga Park, CA (US)

(73) Assignee: KISS-Engineering Inc., Phoenix, AZ (US)

(21) Appl. No.: 17/029,596

(22) Filed: Sep. 23, 2020

Related U.S. Application Data
(63) Continuation-in-part of application No. 16/878,470, filed on May 19, 2020.
Application No. 16/878,470 is a continuation of application No. 16/052,052, filed on Aug. 1, 2018, now Pat. No. 10,690,126.

(51) Int. Cl. F04B 35/00; F02B 75/00; F02B 63/06; F04B 39/12; F04B 39/10; F04B 25/00; F02B 75/20; F04B 39/00; F02B 33/02; F01B 9/02; F04B 27/02

(52) U.S. Cl. CPC F04B 35/002; F02B 75/002; F02B 63/06; F04B 39/12; F04B 39/1073; F04B 25/005; F02B 2075/1808; F04B 39/0005; F04B 39/128; F02B 33/02; F01B 9/023; F04B 27/02; F04B 39/0094; F02B 75/20

(57) ABSTRACT

The present invention is directed to a process for operating a combustion engine having a double-sided piston in a piston cylinder, wherein every stroke of the double-sided piston is a power stroke. Every piston cylinder defines a combustion chamber on each side of the double-sided piston. The process includes igniting a fuel-air mixture in each combustion chamber on each side of double-sided piston during every compression, i.e., at about top dead center and at about bottom dead center. The process utilizes the double-sided piston to achieve two power strokes per piston for each engine cycle.

### RELATED APPLICATIONS

This application is a continuation-in-part of U.S. patent application Ser. No. 16/878,470, filed May 19, 2020, now pending, which is a continuation of U.S. patent application Ser. No. 16/052,052, filed Aug. 1, 2018, now U.S. Pat. No. 10,690,126, issued on Jun. 23, 2020.

### BACKGROUND OF THE INVENTION

The present invention is directed to a process for operating a combustion engine that efficiently and compactly provides improved performance having two power strokes per cycle, i.e., a single-stroke cycle. In particular, combustion cylinders enclose double-sided pistons in a straight-line reciprocating pattern where each cylinder has a combustion chamber on each side each piston.

Various types of engine designs have been developed over the years. The most common engine is the conventional reciprocating piston internal combustion engine in which a reciprocating piston is coupled by a connecting rod to the offset crank pins of a crankshaft. The reciprocating motion of the pistons is translated to rotary motion at the crank shaft. Power is delivered by the crank shaft to the driven device such as a vehicle or in stationary application to a pump or other device. Prior art combustion engines are typically designed for either “four-stroke” or “two-stroke” cycles.

A four-stroke engine cycle is one that completes one power cycle for every four piston strokes (full travel of the piston along the cylinder in either direction) during two revolutions of the crankshaft. In a four-stroke engine, each stroke of the piston performs a different function—(1) intake; (2) compression; (3) power (or combustion); and (4) exhaust—before repeating. Thus, in a four-stroke engine every piston has one power stroke in every four strokes.

A two-stroke engine cycle is one that completes one power cycle for every two piston strokes during one revolution of the crankshaft. In a two-stroke engine, two combustion functions are performed in each stroke of the piston—(1) the end of the combustion stroke and beginning of the compression stroke occur at the same time; and (2) intake and exhaust occur at the same time—before repeating. Thus, in a two-stroke engine every piston has one power stroke in every two strokes.

A wide variety of alternate engine designs have been developed over the years in attempts to improve upon the basic engine design described above. These devices may change the cycle dynamics of the engine.

In addition, straight-line, reciprocating piston systems are known to exist, including U.S. Pat. Nos. 7,503,291, 8,109,737, and 9,406,083—all for a reciprocating device with dual chambered cylinders. One major drawback of these systems is that they are designed for multiple-cycle firing such that every cylinder has only one power stroke for every full rotation of the crankshaft, instead relying on other cylinders to complete the rotation of the crankshaft in the cycle.

Accordingly, there is a need for an improved and compact double-sided piston combustion engine that more efficiently utilizes available combustion chambers, generates more torque, and produces fewer emissions. The present invention fulfills these needs and provides other related advantages.

### SUMMARY OF THE INVENTION

The present invention relates to a process for operating a combustion engine having a cylinder enclosing a double-sided piston and defining two combustion chambers on each side of the double-sided piston. This engine having a double-sided piston is capable of being operated such that every cylinder piston undergoes two power strokes every complete cycle, i.e., revolution of the crank shaft.

The engine design of the invention is extremely versatile and compact and allows for easy increase in size and horsepower by the addition of more cylinders through the addition of basic components with minor modifications. The design utilizes fewer components than conventional internal combustion engine designs.

More particularly, the process for operating a combustion engine begins with providing a combustion engine having a primary cylinder enclosing a double-sided piston and defining a first combustion chamber and a second combustion chamber on opposite sides of the double-sided piston. The double-sided piston reciprocates between top dead center in the first combustion chamber and bottom dead center in the second combustion chamber relative to a crankshaft. Top dead center refers to the position when the piston is farthest from the crankshaft. Bottom dead center refers to the position when the piston is closest to the crankshaft.

The process continues with igniting a first fuel-air mixture in the first combustion chamber every time the double-sided piston is about at top dead center. The position of the double-sided piston being “about at top dead center” refers to the igniting step occurring immediately before, right at, or immediately after top dead center—depending upon the programmed timing of the engine. The process continued with igniting a second fuel-air mixture in the second combustion chamber every time the double-sided piston is about at bottom dead center.

The step of igniting the first fuel-air mixture pushes the double-sided piston in a downward direction toward bottom dead center in the second combustion chamber. Similarly, the step of igniting the second fuel-air mixture pushes the double-sided piston in an upward direction toward top dead center in the first combustion chamber.

The step of igniting the first fuel-air mixture produces combustion gases in the first combustion chamber, and further includes exhausting the combustion gases through an exhaust port intermediate the first combustion chamber and the second combustion chamber. The exhaust port is opened as a first face of the double-sided piston passes the exhaust port when moving in the downward direction toward bottom dead center. The process may include injecting air into the first combustion chamber to force the combustion gases out of the exhaust port under pressure.

The process further includes injecting fuel into the first combustion chamber after the first face of the double-sided piston passes the exhaust port when moving in the upward direction toward top dead center. The first face of the double-sided piston may have a chamfered edge so as to open the exhaust port immediately before the first face passes the exhaust port. The chamfered edge also creates a burn ring around the first face of the double-sided piston in the step of igniting the first fuel-air mixture.

The step of igniting the second fuel-air mixture produces combustion gases in the second combustion chamber and includes exhausting the combustion gases through the exhaust port intermediate the second combustion chamber and the first combustion chamber. The exhaust port is opened as a second face of the double-sided piston passes the exhaust port when moving in the upward direction toward top dead center. The process further includes injecting air into the second combustion chamber to force the combustion gases out of the exhaust port under pressure.

The process continues with injecting fuel into the second combustion chamber after the second face of the double-sided piston passes the exhaust port when moving in the downward direction toward bottom dead center. The second face of the double-sided piston has a chamfered edge so as to open the exhaust port immediately before to the second face passes the exhaust port. The chamfered edge also creates a burn ring around the second face of the double-sided piston in the step of igniting the second fuel-air mixture.

The combustion engine may have a secondary cylinder enclosing a second double-sided piston and defining a third combustion chamber and a fourth combustion chamber on opposite sides of the second double-sided piston. The second double-sided piston reciprocates between bottom dead center in the third combustion chamber and top dead center in the fourth combustion chamber relative to the crankshaft. The primary cylinder and the secondary cylinder are linearly disposed on opposite sides of the crankshaft.

The process including the secondary cylinder continues with igniting a third fuel-air mixture in the third combustion chamber every time the second double-sided piston is about at bottom dead center, and igniting a fourth fuel-air mixture in the fourth combustion chamber every time the second double-sided piston is about at top dead center. The step of igniting the third fuel-air mixture occurs simultaneously with the step of igniting the first fuel-air mixture, and the step of igniting the fourth fuel-air mixture occurs simultaneously with the step of igniting the second fuel air mixture.

As with the primary cylinder, the step of igniting the third fuel-air mixture pushes the second double-sided piston in an upward direction toward top dead center in the fourth combustion chamber and the step of igniting the fourth fuel-air mixture pushes the second double-sided piston in a downward direction toward bottom dead center in the third combustion chamber.

In addition, the combustion engine may have a tertiary cylinder and a quaternary cylinder. The tertiary cylinder encloses a third double-sided piston and defines a fifth combustion chamber and a sixth combustion chamber on opposite sides of the third double-sided piston. The third double-sided piston reciprocates between top dead center in the fifth combustion chamber and bottom dead center in the sixth combustion chamber relative to the crankshaft. The quaternary cylinder encloses a fourth double-sided piston and defines a seventh combustion chamber and an eighth combustion chamber on opposite sides of the fourth double-sided piston. The fourth double-sided piston reciprocates between bottom dead center in the seventh combustion chamber and top dead center in the eighth combustion chamber relative to the crankshaft. The tertiary cylinder and the quaternary cylinder are linearly disposed on opposite sides of the crankshaft. The tertiary cylinder may be disposed adjacent to the secondary cylinder and the quaternary cylinder may be disposed adjacent to the primary cylinder.

The process with the tertiary and quaternary cylinders continues with igniting a fifth fuel-air mixture in the fifth combustion chamber every time the third double-sided piston is about at top dead center, igniting a sixth fuel-air mixture in the sixth combustion chamber every time the third double-sided piston is about at bottom dead center, igniting a seventh fuel-air mixture in the Seventh combustion chamber every time the fourth double-sided piston is about at bottom dead center, and igniting an eighth fuel-air mixture in the eighth combustion chamber every time the fourth double-sided piston is about at top dead center.

The steps of igniting the fifth fuel-air mixture and igniting the seventh fuel-air mixture both occur simultaneously with the steps of igniting the first fuel-air mixture and igniting the third fuel-air mixture. The steps of igniting the sixth fuel-air mixture and igniting the eighth fuel-air mixture both occur simultaneously with the steps of igniting the second fuel air mixture and igniting fourth fuel-air mixture.

The step of igniting the fifth fuel-air mixture pushes the third double-sided piston in a downward direction toward bottom dead center in the sixth combustion chamber, and the step of igniting the seventh fuel-air mixture pushes the fourth double-sided piston in an upward direction toward top dead center in the eighth combustion chamber.

The step of igniting the sixth fuel-air mixture pushes the third double-sided piston in an upward direction toward top dead center in the fifth combustion chamber, and the step of igniting the eighth fuel-air mixture pushes the fourth double-sided piston in a downward direction toward bottom dead center in the seventh combustion chamber.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top plan view of the combustion engine according to the present invention with the piston in the primary cylinder at top dead center;

FIG. 2 is a top plan view of the combustion engine according to the present invention with the piston in the primary cylinder immediately before 90 degrees after top dead center;

FIG. 3 is a top plan view of the combustion engine according to the present invention with the piston in the primary cylinder immediately after 90 degrees after top dead center;

FIG. 4 is a top plan view of the combustion engine according to the present invention with the piston in the primary cylinder at bottom dead center or 180 degrees after top dead center;

FIG. 5 is a top plan view of the combustion engine according to the present invention with the piston in the primary cylinder at immediately before 270 degrees after top dead center;

FIG. 6 is a top plan view of the combustion engine according to the present invention with the piston in the primary cylinder at immediately after 270 degrees after top dead center;

FIG. 7 is a see-through perspective view of the combustion engine of FIG. 4;

FIG. 8A is a close up, cut-away perspective view of the primary cylinder showing a face of the double-sided piston relative to the exhaust port; and

FIG. 8B is a close up, cut-away perspective view of the primary cylinder showing an opposite face of the double-sided piston relative to the exhaust port.

### DETAILED DESCRIPTION OF THE PREFERRED EMBODIMENTS

In the following detailed description, the combustion engine of the present invention is generally referred to by reference numeral 10. The engine 10 generally has at least a primary cylinder 20, but may include multiple cylinders, i.e., secondary cylinder 30, tertiary cylinder, 40, quaternary cylinder 50, and so on. The following detailed description will generally describe a particular embodiment of the engine 10 having four cylinders, but the engine 10 may be constructed with one cylinder, two cylinders, four cylinders or any appropriate number of cylinders considering balance and torque from reciprocating forces.

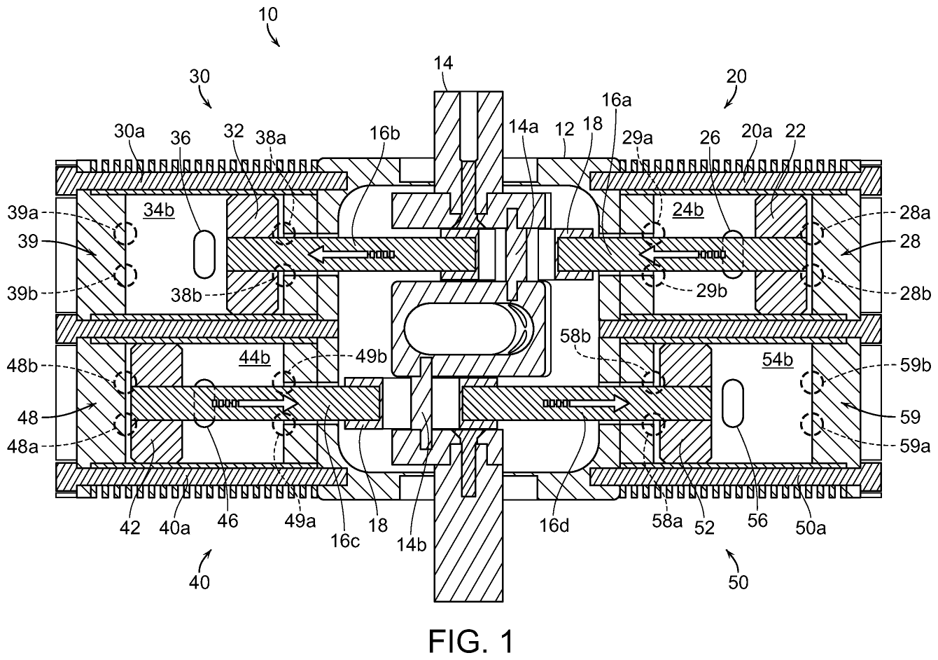

As shown in FIGS. 1-7, the engine 10 includes a crankcase 12 enclosing a crankshaft 14 having connecting journals 14a, 14b. The crankshaft 14 is connected to linearly disposed piston rods 16 by a scotch yoke 18 or similarly functioning rectilinear, rotary-motion translation device.

The primary cylinder 20 contained in a housing 20a is disposed on one side of the crankcase 12. When included, the secondary cylinder 30 contained in a housing 30a is disposed on a second side of the crankcase 12 linearly opposite the primary cylinder 20. In addition, when included, the tertiary cylinder 40 contained in housing 40a may be adjacent to the secondary cylinder 30 and on the side of the crankcase 12 opposite the primary cylinder 20. The quaternary cylinder 50 contained in housing 50a is disposed adjacent the primary cylinder 20 and on the side of the crankcase 12 linearly opposite the tertiary cylinder 40.

The primary cylinder 20 contains a reciprocating double-sided piston 22 connected to one of the piston rod 16a. The double-sided piston 22 has a first face 22a and second face 22b. Since the double-sided piston 22 is reciprocating, the primary cylinder 20 defines two combustion chambers 24a, 24b—with a single cylinder 20 and piston 22 being capable of two power strokes with every reciprocating motion.

For naming convention purposes, the first face 22a of the piston 22 is oriented toward the first combustion chamber 24a distal from the crankcase 12, and the second face 22b of the piston 22 is oriented toward the second combustion chamber 24b proximate to the crankcase 12. Following this naming convention, when the piston 22 is at full compression in the first combustion chamber 24a, the piston 22 is at top dead center for the primary cylinder 20, and when the piston 22 is at full compression in the second combustion chamber 24b, the piston 22 is at bottom dead center for the primary cylinder 20. “Top dead center” refers to the point most distal from the crankcase 12. “Bottom dead center” refers to the point most proximate to the crankcase 12.

The primary cylinder 20 and primary cylinder housing 20a include an exhaust port 26, air-fuel intakes (or injectors) 28, 29. The exhaust port 26 is disposed intermediate the first combustion chamber 24a and the second combustion chamber 24b, preferably at about a midpoint there between. In addition, the first combustion chamber 24a includes an air injector 28a and a fuel injector 28b at top dead center of the primary cylinder 20. The second combustion chamber 24b includes an air injector 29a and a fuel injector 29b at bottom dead center of the primary cylinder 20. Depending on the type of engine, i.e., gasoline, diesel, etc., the primary cylinder 20 will have appropriate combustion components, i.e., spark plugs, glow plugs, etc., (not shown).

When included, each of the secondary, tertiary, and quaternary cylinders 30, 40, 50 include similar components in similar configurations. Because of the linear disposition of the piston rods 16 about the crankshaft 14, the engine 10 may either have a single cylinder (primary cylinder 20) or a plurality of opposite disposed cylinders. For example, both primary and secondary cylinders 20, 30, or all of primary, secondary, tertiary, and quaternary 20, 30, 40, and 50, or any multiples of two. Preferably, the engine 10 does not include an odd number of multiple cylinders to avoid torsional forces associated with an unmatched piston cylinder. The remainder of this detailed description will describe a preferred embodiment of the engine 10 that includes primary, secondary, tertiary, and quaternary 20, 30, 40, and 50.

Following this similar numbering convention, the secondary cylinder 30 has a secondary housing 30a that encloses a double-sided piston 32 having a first face 32a and a second face 32b. The secondary cylinder 30 defines a third combustion chamber 34a—at bottom dead center—and a fourth combustion chamber 34b—at top dead center. Because the secondary cylinder 30 is oppositely disposed relative to the primary cylinder 20, the position of the pistons 22, 32 will be opposite, i.e., when the piston 22 of the primary cylinder 20 is at top dead center, the piston 32 of the secondary cylinder 30 is at bottom dead center—and vice versa. The secondary cylinder 30 has an exhaust port 36, air/fuel intakes 38a, 38b in the third chamber 34a, and air/fuel intakes 39a, 39b in the fourth chamber 34b disposed and oriented similar to those described in the primary cylinder 20.

Similarly, the tertiary cylinder 40 has a tertiary housing 40a that encloses a double-sided piston 42 having a first face 42a and a second face 42b. The tertiary cylinder 40 defines a fifth combustion chamber 44a—at top dead center—and a sixth combustion chamber 44b—at bottom dead center. Because the tertiary cylinder 40 is alternately disposed relative to the primary cylinder 20, the position of the pistons 22, 42 will be mirrored, i.e., when the piston 22 of the primary cylinder 20 is at top dead center, the piston 42 of the tertiary cylinder 40 is also at top dead center—and vice versa. The tertiary cylinder 40 has an exhaust port 46, air/fuel intakes 48a, 48b in the fifth chamber 44a, and air/fuel intakes 49a, 49b in the sixth chamber 44b disposed and oriented similar to those described in the primary cylinder 20.

Finally, the quaternary cylinder 50 has a quaternary housing 50a that encloses a double-sided piston 52 having a first face 52a and a second face 52b. The quaternary cylinder 50 defines a seventh combustion chamber 54a—at bottom dead center—and an eighth combustion chamber 54b—at top dead center. Because the quaternary cylinder 50 is adjacently disposed relative to the primary cylinder 20, the position of the pistons 22, 52 will be opposite, i.e., when the piston 22 of the primary cylinder 20 is at top dead center, the piston 52 of the quaternary cylinder 50 is at bottom dead center—and vice versa. The quaternary cylinder 50 has an exhaust port 56, air/fuel intakes 58a, 58b in the seventh chamber 54a, and air/fuel intakes 59a, 59b in the eighth chamber 54b disposed and oriented similar to those described in the primary cylinder 20.

In the following paragraphs, the combustion cycle is described with particular reference to the primary cylinder 20. As with typical combustion engines, a complete combustion cycle involves the processes of intake, compression, combustion, and exhaust repeating in sequence so long as the engine remains running. Throughout this cycle, the piston 22 reciprocates between top dead center and bottom dead center. Because the primary cylinder 20 and piston 22 are double-sided, defining two opposing combustion chambers 24a, 24b, the primary cylinder 20 experiences two separate combustion cycles—one associated with each chamber 24a, 24b.

Combustion Cycle in First Combustion Chamber 24a

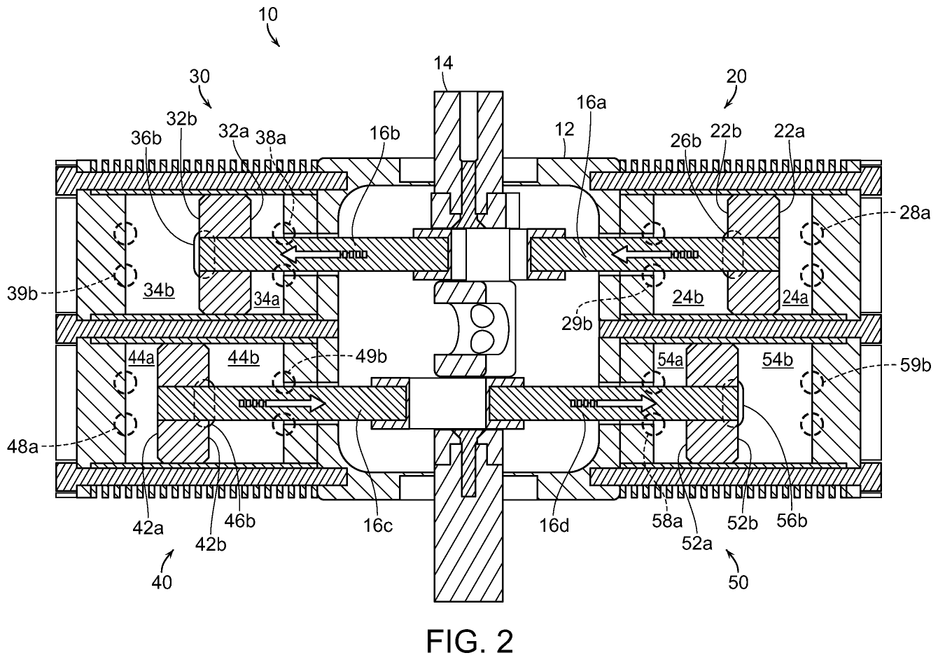

With reference to the first combustion chamber 24a, the piston 22 begins at top dead center, with the first face 22a fully extended into the first combustion chamber 24a. (FIG. 1) Because of the repeating cycle of combustion, once the engine is running, at top dead center, the first chamber 24a contains an air-fuel mixture from the prior intake part of the cycle. The first combustion chamber 24a then undergoes a combustion/ignition process, which forces the piston 22 down through the cylinder 20 away from top dead center. (FIG. 2) Continuing this down stroke, the piston 22 reaches the midpoint of the cylinder 20 at ninety degrees after top dead center and continues toward bottom dead center.

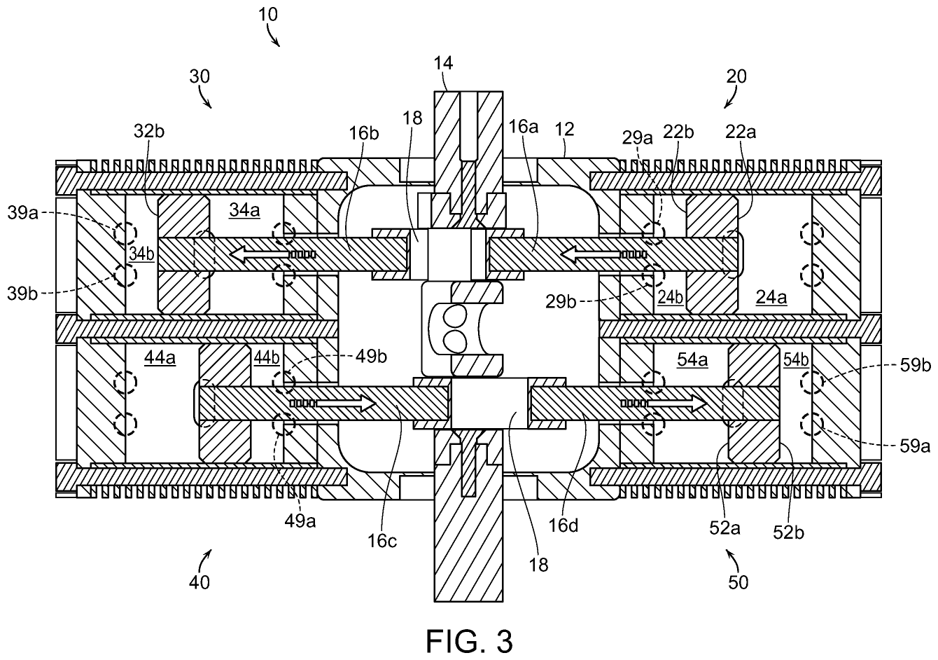

A few degrees after this midpoint in the down stroke, the first face 22a of the piston 22 passes a top edge 26a of the exhaust port 26, whereupon the exhaust port 26 is opened and exhaust gases from the combustion process are released. (FIG. 3) Simultaneously with the opening of the exhaust port 26, the air intake 28a begins injecting air into the first combustion chamber 24a. This injection of air forces the combustion gases out of the exhaust port 26 under pressure. Because the combustion gases are exhausted under pressure, the engine 10 may include a muffler or other exhaust devices (not shown).

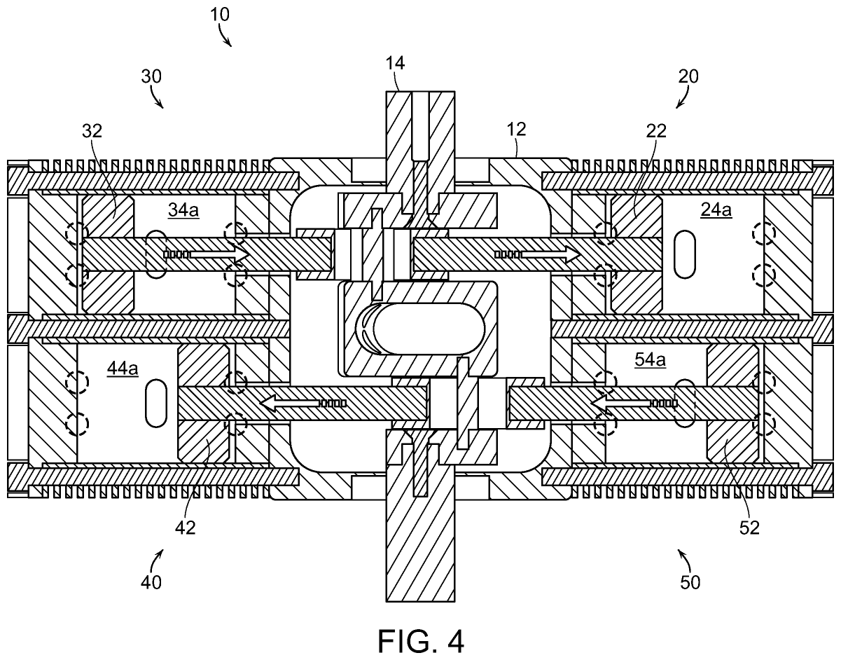

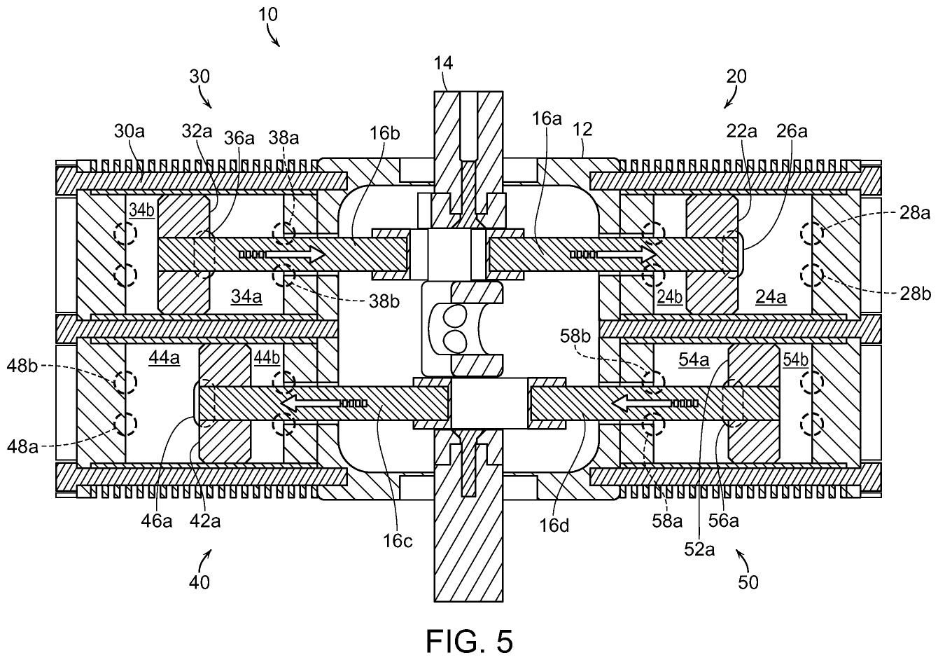

As the piston 22 continues the down stroke, it reaches bottom dead center or one-hundred eighty degrees after top dead center in the primary cylinder 20 (FIG. 4), whereupon the piston 22 reverses direction and begins its upstroke back toward top dead center. (This reversal of direction coincides with the combustion process in the cycle for the second combustion chamber 24b.) Again, the piston 22 approaches and reaches the midpoint of the cylinder 20, which is now two-hundred seventy degrees after top dead center. A few degrees before this midpoint in the up stroke, the first face 22a of the piston 22 eclipses the top edge 26a of the exhaust port 26, effectively closing the same. (FIG. 5) During the entire stroke from ninety degrees after top dead center to two-hundred seventy degrees after top dead center, the air intake 28a in the first chamber 24a has been injecting air. This has eliminated all of the combustion gases and filled the first chamber 24a with fresh air.

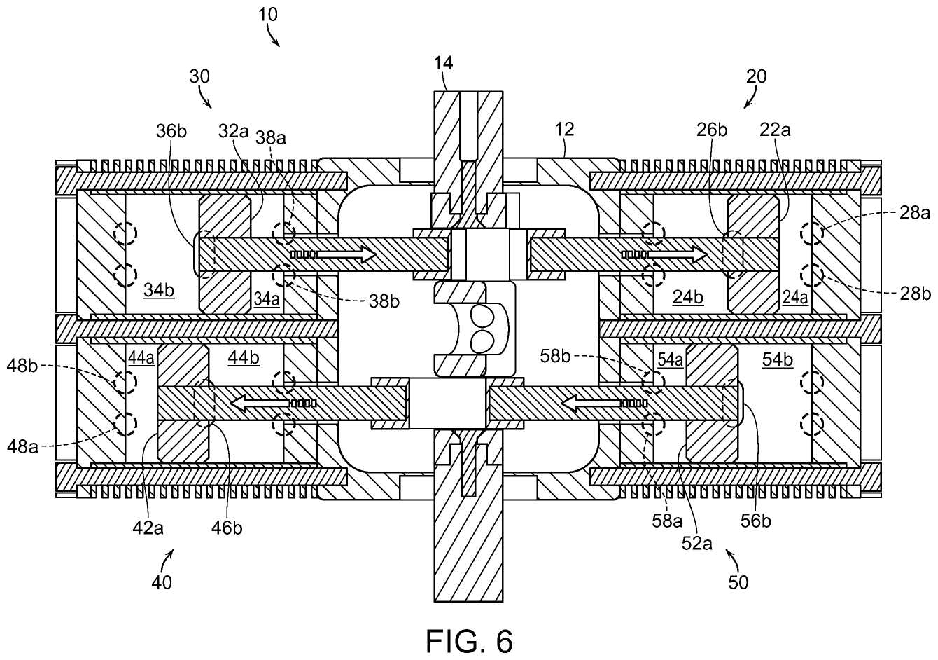

Simultaneously with the closing of the exhaust port 26, the fuel intake 28b begins injecting fuel into the first chamber 24a. The piston 22 continues the up stroke toward top dead center (FIG. 6)—this time three-hundred sixty degrees after top dead center at the start of the cycle. The air intake 28a and the fuel intake 26b are preferably timed with the movement of the piston 22 in the first chamber 24a such that a sufficient amount of both fuel and air are injected for a proper mixture for combustion. The movement of the piston 22 toward top dead center compresses the air-fuel mixture in the first chamber 24a. When the piston 22 reaches top dead center in the first chamber 24a, the air-fuel mixture is fully compressed and is ready to begin the cycle again. This fully compressed air-fuel mixture serves as the air-fuel mixture described at the start of the cycle as being from the prior intake part of the cycle. The cycle then repeats, starting again with the combustion/ignition process.

With regard to the injection of air, in an alternative embodiment, the air injector 28a may be delayed until a point in time closer to the piston 22 covering the exhaust port 26 on the up stroke. In this way, the exhaust gases can still be pressurized when ejected from the cylinder 20 allowing for muffling of the exhaust. Once the piston 22 covers the exhaust port 26, the resulting pressure build-up in the first chamber 24a keeps the air injector valve 28a closed until the pressure is released through the exhaust port 26 in the next cycle. As the piston 22 moves past the exhaust port 26, the pressure continues to build-up until the air injection valve 28a is closed. The fuel intake 28b into the first chamber 24a is timed with the compression up stroke once the piston 22 has covered the exhaust port 26.

Combustion Cycle in Second Combustion Chamber 24b

Simultaneously with the combustion cycle described in the first chamber 24a, the second chamber 24b undergoes a similar but opposite cycle. Because the primary cylinder 20 and piston 22 are double-sided, the combustion cycle of the second combustion chamber 24b is one-hundred eighty degrees opposite the combustion cycle of the first combustion chamber 24a. The following description will explain the combustion cycle for the second combustion chamber 24b in the same order starting with combustion, exhaust, intake, and compression.

In the second combustion chamber 24b, the combustion/ignition event of the cycle occurs at bottom dead center, with the second face 22b of the piston 22 fully extended into the second combustion chamber 24b. (FIG. 4) In the first combustion chamber 24a, at bottom dead center, the first face 22a of the piston 22 is fully withdrawn from the first combustion chamber 24a.

As above, the second chamber 24b contains an air-fuel mixture from the prior intake process of the cycle. The second combustion chamber 24b undergoes the combustion/ignition process, which forces the piston 22 up through the cylinder 20 away from bottom dead center. (FIG. 5) During this up stroke, the piston 22 reaches the midpoint of the cylinder 20 at ninety degrees after bottom dead center and continues toward top dead center.

A few degrees after this midpoint in the up stroke, the second face 22b of the piston 22 passes a bottom edge 26b of the exhaust port 26, whereupon the exhaust port 26 is opened and exhaust gases from the combustion process are released. (FIG. 6) In the cycle for the first combustion chamber 24a, at a few degrees before the midpoint, the first face 22a of the piston 22 passes the top edge 26a, closing the exhaust port 26 as described above. (FIG. 5)

Simultaneously with the opening of the exhaust port 26 in the second chamber 24b, the air intake 29a begins injecting air into the second combustion chamber 24b. This injection of air forces the combustion gases out of the exhaust port 26 under pressure. Because of this pressure, the engine 10 may use a muffler or other exhaust devices (not shown).

As the piston 22 continues the up stroke, it reaches top dead center or one-hundred eighty degrees after bottom dead center in the primary cylinder 20 (FIG. 1), whereupon the piston 22 reverses direction and begins its down stroke back toward bottom dead center. (This reversal of direction coincides with the combustion/ignition event in the cycle for the first combustion chamber 24a.)

Again, the piston 22 approaches and reaches the midpoint of the cylinder 20, which is two-hundred seventy degrees after bottom dead center. A few degrees before this midpoint in the down stroke, the second face 22b of the piston 22 eclipses the bottom edge 26b of the exhaust port 26, effectively closing the same. (FIG. 2) During the entire stroke from ninety degrees after bottom dead center to two-hundred seventy degrees after bottom dead center, the air intake 29a in the second chamber 24b has been injecting air, eliminating all of the combustion gases and filling the second chamber 24b with fresh air.

Simultaneously with the closing of the exhaust port 26, the fuel intake 29b begins injecting fuel into the second chamber 24b. The piston 22 continues the down stroke toward bottom dead center (FIG. 3)—this time three-hundred sixty degrees after bottom dead center at the start of the cycle. The air intake 29a and the fuel intake 29b are preferably timed with the movement of the piston 22 in the second chamber 24b such that a sufficient amount of both fuel and air are injected for a proper mixture for combustion. The movement of the piston 22 toward bottom dead center compresses the air-fuel mixture in the second chamber 24b. When the piston 22 reaches bottom dead center in the second chamber 24b (FIG. 4), the air-fuel mixture is fully compressed and is ready to begin the cycle again. This fully compressed air-fuel mixture serves as the air-fuel mixture described at the start of the cycle as being from the prior intake part of the cycle.

With regard to the injection of air, in an alternative embodiment, the air may be injected at any point prior to the piston 22 covering the exhaust port 26 on the down stroke. In this way, the exhaust gases can still be pressurized when ejected from the cylinder 20 allowing for muffling of the exhaust. Once the piston 22 covers the exhaust port, the resulting pressure build-up in the second chamber 24b keeps the air injector valve 29a closed until the pressure is released through the exhaust port 26 in the next cycle. As the piston 22 moves past the exhaust port 26, the pressure continues to build-up until the air injection valve 29a is closed. The fuel intake 29b into the second chamber 24b is timed with the compression up stroke once the piston 22 has covered the exhaust port 26.

Combustion Cycles in Other Cylinders 30, 40, 50

The piston rods 16a, 16c from the primary and tertiary cylinders 20, 40 are connected in a straight line configuration with the piston rods 16b, 16d from the secondary and quaternary cylinder 30, 50, all through the scotch yokes 18 on the crankshaft 14. Because of this configuration and the naming convention of the combustion chambers, all of the odd numbered chambers—first (24a), third (34a), fifth (44a), and seventh (54a)—undergo the same combustion cycle processes at that same time. Similarly, all of the even numbered chambers—second (24b), fourth (34b), sixth (44b), and eighth (54b)—undergo the same combustion cycle processes at that same time. The primary and tertiary cylinders 20, 40 experience the cycle processes at the same relative positions, i.e., relative to top dead center and bottom dead center. Similarly, the secondary and quaternary cylinders 30, 50 also experience the cycle processes at the same relative positions. However, the secondary and quaternary cylinders 30, 50 experience the cycle processes at opposite relative positions when compared to both the primary and tertiary cylinders 20, 40.

All parts of the engine 10 are preferably made from carbon fiber or similar material, except for the crankshaft 14, which must be made out of steel or similarly strong material for durability. In addition, because of the materials and manner of construction, there is no oil in any of the cylinders 20, 30, 40, 50. The only oil needed is in the crankcase 12 because of the material of the crankshaft 14.

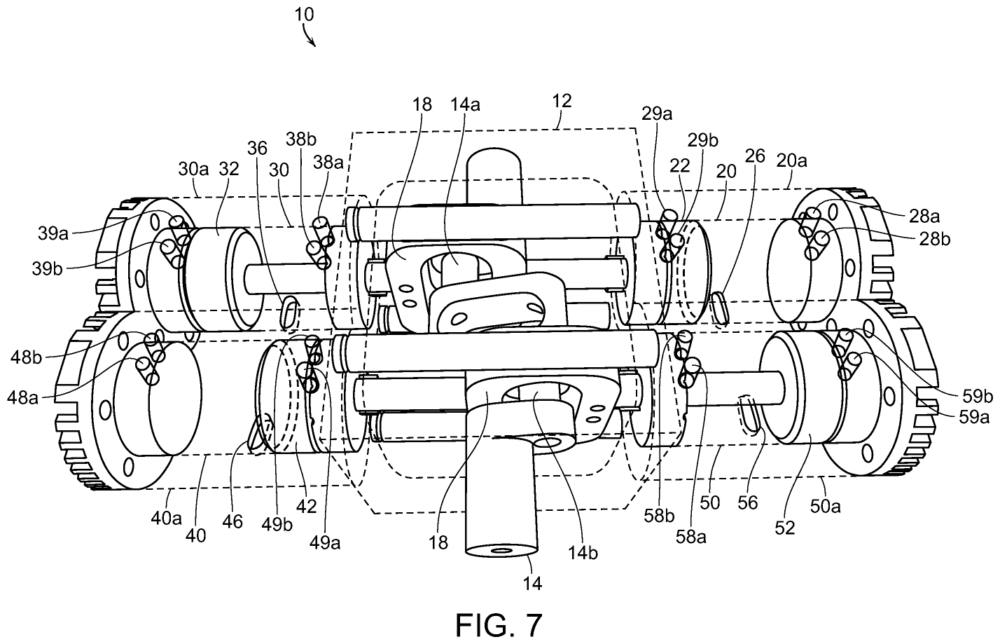

FIG. 7 further illustrates the relative positions of the cylinders (20, 30, 40, 50), pistons, (22, 32, 42, 52), exhaust ports (26, 36, 46, 56), air intakes (28a, 29a, 38a, 39a, 48a, 49a, 58a, 59a) and fuel intakes (28b, 29b, 38b, 39b, 48b, 49b, 58b, 59b)—particularly in relation to the crankcase 12 and crank shaft 14. Although the exhaust ports are shown on opposite sides of the cylinders relative to the air/fuel intakes, such is not necessary for this engine 10. The exhaust ports and intakes may be on the same side of cylinders. However, positioning the exhaust ports on opposite sides of the cylinders from the intakes avoids possible crowding of such components on the exterior of the engine 10.

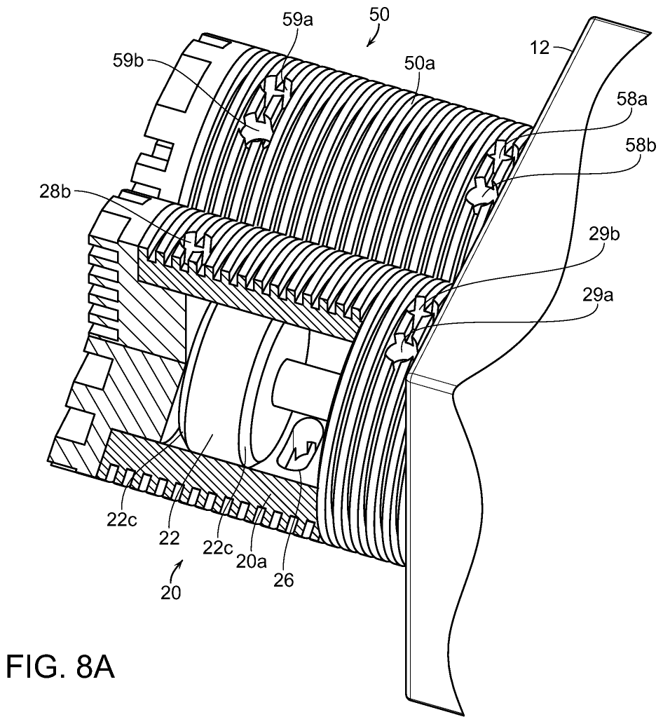

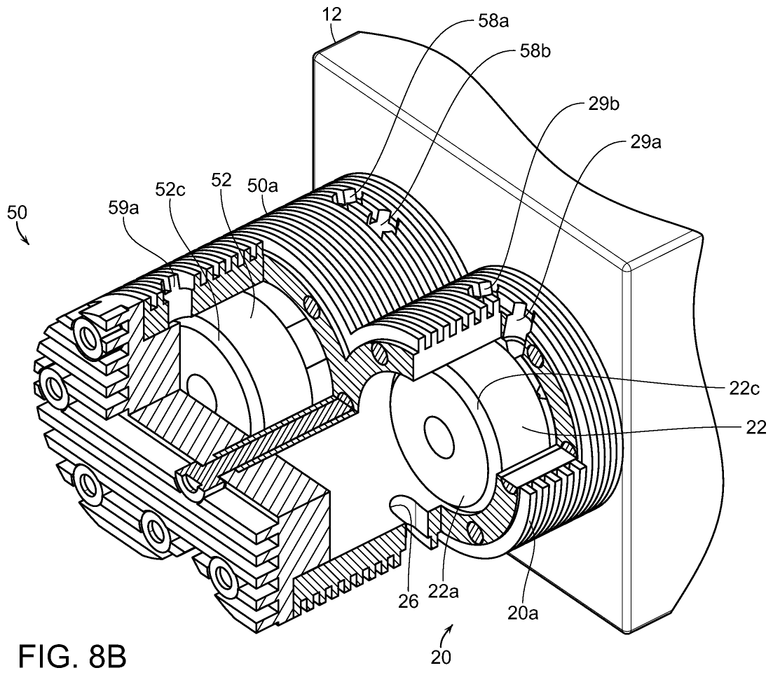

FIGS. 8A and 8B illustrate partial cut-away views of the primary cylinder 20 and quaternary cylinder 50. In particular, the partial cut-away of FIG. 8A shows the interior of the primary cylinder 20 with the piston 22 near top dead center in the first combustion chamber 24a. It is clear that the exhaust port 26 is not covered with the piston 22 in this position. The partial cut-away of FIG. 8B shows the interiors of both the primary cylinder 20 and the quaternary cylinder 50. In this view, the piston 22 of the primary cylinder 20 is near bottom dead center in the second combustion chamber 24b. Again, the exhaust port 26 is not covered with the piston 22 in this position. Also in this view, the piston 52 of the quaternary cylinder 50 is near top dead center in the eighth combustion chamber 54b.

In addition, in FIGS. 8A and 8B, piston 22 is shown with each face 22a, 22b having a chamfered corner 22c. This chamfered corner 22c results in either an advancement of the opening of the exhaust port 26 or a delay in the closing of the exhaust port 26, depending on the position in the combustion cycle. The advancement or delay provided by the chamfered corners 22c allows for preparing a more compact engine 10, particularly with the double sided piston 22 and double-ended cylinder 20. These chamfered corners 22c can be repeated on each piston 32, 42, 52 in each cylinder 30, 40, 50. FIG. 8B shows the chamfered corners 52c on piston 52 in quaternary cylinder 50.

Because the cylinders 20, 30, 40, 50 and pistons 22, 32, 42, and 52 are double sided and have oppositely disposed combustion chambers 24, 34, 44, and 54, the inventive engine 10 avoids the problem of blow-by gases experienced by prior art engines. For example, if any combustion gases from the first combustion chamber 24a blow-by the piston 22 into the second combustion chamber 24b, such blow-by gases will either exhaust with the combustion gases or be combusted with the intake gases in the second combustion chamber 24b—and vice versa. The same process will occur with blow-by gasses in each of the other cylinders 30, 40, 50.

The inventive system is completely scalable from nano-sized engines to large stationary engines. The construction has a reduced demand for lubricating oils and completely eliminates oil from the combustion chambers. It also requires reduced fuel usage when compared to typical combustion engines. The system is able to operate either by compression or combustion. It can be either air cooled or water cooled. There is a low production cost because of fewer and less diverse parts. The system can also serve as a power plant to drive an electrical generator, while providing both air and liquid compression.

The system has application in many fields, including, home generators, commercial/industrial generators, standalone use for remote locations, trailer mounted to airport tarmac use, emergency short term and long term use, aviation, un-manned military aviation, ultra-light personal aviation, motor vehicle compressors, engines, motorcycles, kit vehicles, golf carts, heavy diesel engines, marine vessels, military vehicles, agriculture pumps, lifts and winches, and an off-grid power supply.

The system can be manufactured from carbon fiber housing and crankcase, with a steel alloy crankshaft. Fuel injector design allows for use with gasoline, diesel, propane, or practically any other liquid or gaseous fuel. The system is low profile with a high power-to-weight ratio. It can be air cooled or water cooled and use pressurized lubrication in the crankcase, with no lubrication required in the cylinders. It can use an electric start/ignition and power system. Calculated performance can reach as much as 1 hp per cubic inch—330 hp @3000 rpm, with usable torque as high as 450 ft-lb @ 2000 rpm.

Although several embodiments have been described in detail for purposes of illustration, various modifications may be made without departing from the scope and spirit of the invention. Accordingly, the invention is not to be limited, except as by the appended claims.

What is claimed is:

1. A process for operating a combustion engine, comprising the steps of:
providing a combustion engine having a primary cylinder enclosing a double-sided piston and defining a first combustion chamber and a second combustion chamber on opposite sides of the double-sided piston, wherein the double-sided piston reciprocates between top dead center in the first combustion chamber and bottom dead center in the second combustion chamber relative to a crankshaft;
igniting a first fuel-air mixture in the first combustion chamber every time the double-sided piston is about at top dead center; and
igniting a second fuel-air mixture in the second combustion chamber every time the double-sided piston is about at bottom dead center.

2. The process of claim 1, wherein the step of igniting the first fuel-air mixture pushes the double-sided piston in a downward direction toward bottom dead center in the second combustion chamber.

3. The process of claim 2, wherein the step of igniting the second fuel-air mixture pushes the double-sided piston in an upward direction toward top dead center in the first combustion chamber.

4. The process of claim 3, wherein the step of igniting the first fuel-air mixture produces combustion gases in the first combustion chamber, further comprising the step of:
exhausting the combustion gases through an exhaust port intermediate the first combustion chamber and the second combustion chamber, wherein the exhaust port is opened as a first face of the double-sided piston passes the exhaust port when moving in the downward direction toward bottom dead center.

5. The process of claim 4, further comprising the step of injecting air into the first combustion chamber to force the combustion gases out of the exhaust port under pressure.

6. The process of claim 5, further comprising the step of injecting fuel into the first combustion chamber after the first face of the double-sided piston passes the exhaust port when moving in the upward direction toward top dead center.

7. The process of claim 4, wherein the first face of the double-sided piston has a chamfered edge so as to open the exhaust port immediately before the first face passes the exhaust port, and creates a burn ring around the first face of the double-sided piston in the step of igniting the first fuel-air mixture.

8. The process of claim 3, wherein the step of igniting the second fuel-air mixture produces combustion gases in the second combustion chamber, further comprising the step of:
exhausting the combustion gases through an exhaust port intermediate the second combustion chamber and the first combustion chamber, wherein the exhaust port is opened as a second face of the double-sided piston passes the exhaust port when moving in the upward direction toward top dead center.

9. The process of claim 8, further comprising the step of injecting air into the second combustion chamber to force the combustion gases out of the exhaust port under pressure.

10. The process of claim 9, further comprising the step of injecting fuel into the second combustion chamber after the second face of the double-sided piston passes the exhaust port when moving in the downward direction toward bottom dead center.

11. The process of claim 8, wherein the second face of the double-sided piston has a chamfered edge so as to open the exhaust port immediately before to the second face passes the exhaust port, and creates a burn ring around the second face of the double-sided piston in the step of igniting the second fuel-air mixture.

12. The process of claim 3, wherein the combustion engine has a secondary cylinder enclosing a second double-sided piston and defining a third combustion chamber and a fourth combustion chamber on opposite sides of the second double-sided piston, wherein the second double-sided piston reciprocates between bottom dead center in the third combustion chamber and top dead center in the fourth combustion chamber relative to the crankshaft, wherein the primary cylinder and the secondary cylinder are linearly disposed on opposite sides of the crankshaft, further comprising the steps of:
igniting a third fuel-air mixture in the third combustion chamber every time the second double-sided piston is about at bottom dead center; and
igniting a fourth fuel-air mixture in the fourth combustion chamber every time the second double-sided piston is about at top dead center.

13. The process of claim 12, wherein the step of igniting the third fuel-air mixture occurs simultaneously with the step of igniting the first fuel-air mixture, and the step of igniting the fourth fuel-air mixture occurs simultaneously with the step of igniting the second fuel air mixture.

14. The process of claim 13, wherein the step of igniting the third fuel-air mixture pushes the second double-sided piston in an upward direction toward top dead center in the fourth combustion chamber.

15. The process of claim 14, wherein the step of igniting the fourth fuel-air mixture pushes the second double-sided piston in a downward direction toward bottom dead center in the third combustion chamber.

16. The process of claim 15, wherein the combustion engine has a tertiary cylinder enclosing a third double-sided piston and defining a fifth combustion chamber and a sixth combustion chamber on opposite sides of the third double-sided piston, wherein the third double-sided piston reciprocates between top dead center in the fifth combustion chamber and bottom dead center in the sixth combustion chamber relative to the crankshaft, and the combustion engine has a quaternary cylinder enclosing a fourth double-sided piston and defining a seventh combustion chamber and an eighth combustion chamber on opposite sides of the fourth double-sided piston, wherein the fourth double-sided piston reciprocates between bottom dead center in the seventh combustion chamber and top dead center in the eighth combustion chamber relative to the crankshaft, wherein the tertiary cylinder and the quaternary cylinder are linearly disposed on opposite sides of the crankshaft, further comprising the steps of:
igniting a fifth fuel-air mixture in the fifth combustion chamber every time the third double-sided piston is about at top dead center;
igniting a sixth fuel-air mixture in the sixth combustion chamber every time the third double-sided piston is about at bottom dead center;
igniting a seventh fuel-air mixture in the Seventh combustion chamber every time the fourth double-sided piston is about at bottom dead center; and
igniting an eighth fuel-air mixture in the eighth combustion chamber every time the fourth double-sided piston is about at top dead center.

17. The process of claim 16, wherein the steps of igniting the fifth fuel-air mixture and igniting the seventh fuel-air mixture both occur simultaneously with the steps of igniting the first fuel-air mixture and igniting the third fuel-air mixture; and wherein the steps of igniting the sixth fuel-air mixture and igniting the eighth fuel-air mixture both occur simultaneously with the steps of igniting the second fuel air mixture and igniting fourth fuel-air mixture.

18. The process of claim 13, wherein the step of igniting the fifth fuel-air mixture pushes the third double-sided piston in a downward direction toward bottom dead center in the sixth combustion chamber, and the step of igniting the seventh fuel-air mixture pushes the fourth double-sided piston in an upward direction toward top dead center in the eighth combustion chamber.

19. The process of claim 18, wherein the step of igniting the sixth fuel-air mixture pushes the third double-sided piston in an upward direction toward top dead center in the fifth combustion chamber, and the step of igniting the eighth fuel-air mixture pushes the fourth double-sided piston in a downward direction toward bottom dead center in the seventh combustion chamber.
